(19) United States
(12) Patent Application Publication
(10) Pub. No.: US 2004/0210207 A1
(43) Pub. Date: Oct. 21, 2004

(54) Safety dispensing system and method

(76) Inventors: Shai Amisar, Tel Aviv (IL); Baruch Segal, Hod Hasharon (IL); Ronen Radomski, Haifa (IL)

Correspondence Address: FITCH EVEN TABIN AND FLANNERY, 120 SOUTH LA SALLE STREET, SUITE 1600, CHICAGO, IL, 60603-3406, US

(21) Appl. No.: 10/480,611

(22) PCT Filed:
(86) PCT No.: PCT/IL02/00493

(30) Foreign Application Priority Data
Jun. 20, 2001 (IL) 143883

(51) Int. Cl. A61M 5/32

(52) U.S. Cl. 604/415

(57) ABSTRACT

A safety dispensing system for dispensing the fluid contents of a container includes a fastener attached to the container for fastening a seal to an opening formed in the container, a closure attached to the container for closing the opening formed in the container, wherein said closure is substantially vertically displaceable above the container, said closure including, a sealable cap attached to said closure for readily accessing the opening formed in the container, and a tubular piercer attached to said closure such that rotational displacement of said closure results in a complimentary displacement of said tubular piercer and piercing of said seal, thereby facilitating flow of the material contained in the container.

The present invention relates to dispensing systems, in general, and in particular, to a safety dispensing system for dispensing the contents of a variety of containers and vials and to a method of dispensing aforesaid contents utilizing the system of the present invention.

### DEFINITION

The term “medicament container” is used to refer any container for containing valuable fluids, medicaments, prescription drugs and hazardous materials, particularly biological samples, wherein the container may be any one, but not limited to, the following: glass vials, plastic vials and bottles.

### BACKGROUND OF THE INVENTION

It is known that valuable fluids, medicaments, prescription drugs and hazardous materials require careful and safe handling.

Often, such fluids, medicaments, prescription drugs and hazardous materials are stored in glass containers or vials due to the unique properties of glass including transparency, resistance to corrosion and the like. Such vials and other types of similar containers are sealed for the purpose of preventing tampering, and/or preventing spillage and/or guaranteeing freshness of the contents of the containers. The seals are commonly made of vulcanized rubber, silicon and the like.

Once the seal is broken or removed, even if the majority of the contents of the container have been removed already, there is still a risk of the remainder leaking or coming into contact with other materials creating impurities and a potentially hazardous situation.

Various patent publications teach devices permitting the filling of syringes without the use of needles, including the following: U.S. Pat. No. 4,505,709 to Froning et al.; U.S. Pat. No. 4,650,475 to Smith et al.; and U.S. Pat. No. 5,035,689 to Schroeder. Some such devices are described in the following patent publications, as being attachable to a medication vial: U.S. Pat. No. 4,759,756 to Forman et al.; U.S. Pat. No. 4,969,883 to Gilbert et al.; and U.S. Pat. No. 4,944,736 to Holtz. These devices and the methods used to attach them to a standard medication vial are somewhat cumbersome. The design of the respective devices creates difficulties in readily attaching them to the vials, which can easily lead to contamination of the devices, as well as of the vials and their contents.

Other examples of related art are disclosed in U.S. Pat. No. 4,230,112 to Smith; U.S. Pat. No. 4,913,699 to Parsons; and U.S. Pat. No. 4,328,802 to Curley et al. U.S. Pat. No. 5,060,812 to Ogle; U.S. Pat. No. 5,425,465 to Healy; U.S. Pat. No. 5,433,330 to Yatsko et al; and U.S. Pat. No. 5,573,525 to Watson et al, disclose various medication containers facilitating the use of a needle-less syringe. In practice, however, injectable medication is predominantly provided in a container accessible only by means of a hypodermic needle.

U.S. Pat. No. 5,429,256 to Kestenbaum discloses an apparatus which snaps onto the top of a needle pierceable drug vial, thereby facilitating a needle-less syringe to withdraw liquid from the vial. The apparatus includes a female luer within which a ferrule with a sharp lance is disposed. When a male luer is connected to the female luer, the ferrule is displaced and the lance pierces the septum of the drug vial. After liquid is withdrawn, there is no apparent way to reseal the pierced septum other than by removing the female luer from the apparatus. However, once the female luer is so removed, the sharp lance is exposed, creating the danger of an exposed needle.

Further relevant art includes U.S. Pat. Nos. 5,049,129 and 4,804,366, to Zdeb et al.; and U.S. Pat. No. 4,850,978 to Dudar et al.

### SUMMARY OF THE INVENTION

The present invention seeks to provide a dispensing system for dispensing the contents of a container, which substantially prevents spillage as well as substantially prevents contamination thereof by foreign matter.

The present invention further seeks to provide a dispensing system for dispensing the contents of a liquid container for medicaments, biological materials, and the like, wherein the system is configured so as to substantially reduce the risk to medical staff of being impaled by a hypodermic needle during the dispensing of the contents.

There is thus provided, in accordance with a preferred embodiment of the invention, According to the present invention there is provided a safety dispensing system for dispensing the contents of a container including: (a) a container including: (i) a fastener attached to the container for fastening a seal to the opening formed in the container, and (ii) a material contained in the container, and (b) a closure attached to the container for closing an opening formed in the container, wherein the closure is substantially vertically displaceable above the container, the closure including: (i) a sealable cap attached to the closure for readily accessing the opening formed in the container, and (ii) a tubular piercer attached to the closure such that rotational displacement of the closure results in a complimentary displacement of the tubular piercer and piercing of the seal, thereby facilitating flow of the material contained in the container.

According to further embodiments of the system of the present invention, the tubular piercer further includes a filter for filtering the material contained in the container and for removing impurities and debris from the material.

According to still further embodiments of the system of the present invention, the closure further includes an attachment socket formed in the closure for readily accommodating and sealing several types of container dispensing means in the closure.

According to yet further embodiments of the system of the present invention, the tubular piercer is biased with a bias for substantially preventing inadvertent piercing of the seal.

According to still further embodiments of the system of the present invention, the tubular piercer is biased with a bias for substantially preventing removal of the tubular piercer from the seal subsequent to piercing the seal.

According to still further embodiments of the system of the present invention, the closure is threaded such that rotational displacement results in a complimentary vertical displacement of the tubular piercer.

According to further embodiments of the present invention, there is provided a safety dispensing system for dispensing the contents of a container including: (a) a medicament vial including: (i) a medicament, (ii) an opening formed at an upper portion of the medicament vial, (iii) a seal sealing the opening of the medicament vial, and (iv) a fastener for fastening a seal to the opening formed at the upper portion of the vial, and (b) a dispensing adapter attached to the vial, the adapter including a needle for piercing the seal and dispensing the medicament.

According to further embodiments of the system of the present invention, the safety dispensing system further includes a filter attached to the needle for filtering the medicament contained in the container and for removing impurities and debris from the medicament.

According to still further embodiments of the system of the present invention, the needle is biased with a bias for substantially preventing inadvertent piercing of the seal.

According to still further embodiments of the system of the present invention, the needle further includes a valve for controlling the flow of the medicament through the dispensing adapter.

According to still further embodiments of the system of the present invention, the dispensing adapter includes a channel formed in the dispensing adapter for readily accommodating an insert.

According to still further embodiments of the system of the present invention, the insert further includes a recess for readily accommodating a protrusion formed in the dispensing adapter, thereby substantially preventing removal of the needle from the seal.

According to still further embodiments of the system of the present invention, the safety dispensing system further includes a luer-lock.

According to still further embodiments of the system of the present invention, the luer-lock is attached to the adapter, for substantially complimentary rotatable displacement of the luer-lock and the adapter.

According to yet further embodiments of the present invention, there is provided a safety dispensing system for dispensing the contents of a container including: (a) a medicament vial including: (i) a medicament, (ii) an opening formed at an upper portion of the medicament vial, (iii) a seal sealing the opening of the medicament vial, and (iv) a fastener for fastening the seal to the opening formed at the upper portion of the vial, and (b) a rotatable cover attached to the vial, the rotatable cover including: (i) a needle for piercing the seal and dispensing the medicament, (ii) a syringe receptacle formed in the rotatable cover for readily accommodating and sealing a syringe tip in the rotatable cover, and (iii) a protrusion formed in the rotatable cover for securing the rotatable cover subsequent to the needle piercing the seal.

### BRIEF DESCRIPTION OF THE DRAWINGS

The present invention will be more fully understood and appreciated, from the following detailed description, taken in conjunction with the drawings, in which:

FIG. 1A is a perspective view of a container utilizing a safety dispensing system constructed and operative in accordance with a preferred embodiment of the present invention;

FIG. 1B is a cross sectional view of a container utilizing the safety dispensing system of FIG. 1A prior to activation;

FIG. 1C is a cross sectional view of a container utilizing the safety dispensing system of FIG. 1A subsequent to activation;

FIG. 2A is a cross sectional view of a medicament container with a safety dispensing system having an adapter which is rotationally displaceable, constructed and operative in accordance with a second embodiment of the invention, prior to the attachment of the adapter thereof to the medicament container and prior to its activation;

FIG. 2B is a cross sectional view of the medicament container and safety dispensing system of FIG. 2A, subsequent to attachment of the adapter to the medicament container and to activation thereof;

FIG. 3A is a cross sectional view of an upper portion of a medicament container with a safety dispensing system having an adapter which is vertically displaceable, constructed and operative in accordance with a third embodiment of the invention, prior to activation thereof;

FIG. 3B is a view similar to that of FIG. 3A, subsequent to activation of the adapter;

FIG. 4A is a cross sectional view of an upper portion of a medicament container with a safety dispensing system having a vertically displaceable adapter and employing a luer lock, constructed and operative in accordance with a fourth embodiment of the invention, prior to activation thereof;

FIG. 4B is a view similar to that of FIG. 4A, subsequent to activation of the adapter;

FIG. 5A is a partially cut-away view of an upper portion of a medicament container having a safety dispensing system employing a vertically displaceable, lockable piercing element, constructed and operative in accordance with a fifth embodiment of a safety dispensing system, showing the piercing element in an initial position;

FIG. 5B is a view similar to that of FIG. 5A, subsequent to displacement and locking of the piercing element;

FIG. 6A is a partially cut-away view of an upper portion of a medicament container having a safety dispensing system employing a rotationally displaceable, lockable piercing element, constructed an operative in accordance with a sixth embodiment of the invention, showing the piercing element in an initial position;

FIG. 6B is a view similar to that of FIG. 6A, subsequent to displacement and locking of the piercing element; and

FIGS. 7A and 7B are schematic views, prior and during use, of a safety dispensing system fastened to a container, wherein the dispensing system includes a double bored piercing element or needle, so as to facilitate aeration of the interior of the container, shown prior to activation.

### DETAILED DESCRIPTION OF THE INVENTION

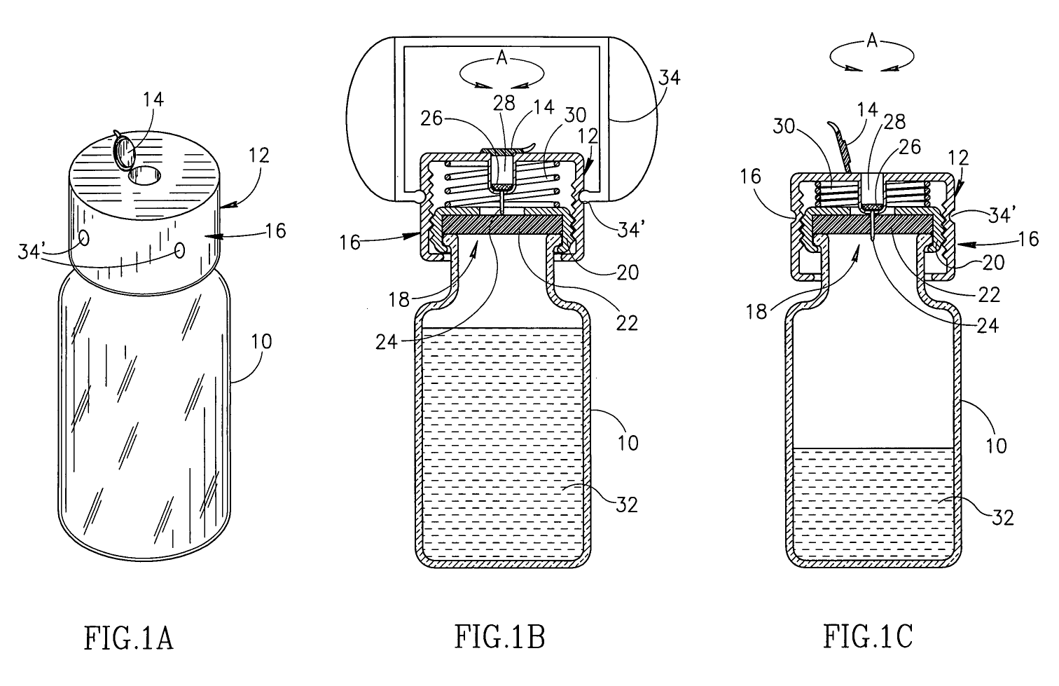

Referring now to FIGS. 1A, 1B and 1C, there is seen a safety dispensing system, constructed and operative in accordance with a preferred embodiment of the present invention. The system includes a container, referenced 10, a closure referenced generally 12, and a sealable cap 14 formed integrally therewith. Closure 12 has formed therewith a rotator 16, for readily facilitating rotational displacement of closure 12. Referring now specifically to FIGS. 1B and 1C, the container and dispensing system are seen in cross sectional view, prior and subsequent, respectively, to the rotational displacement of closure 12. As seen in FIG. 1B, sealable cap 14 is in a closed position prior to container 10 being used. It is seen that container 10 has an opening 18 formed at an upper portion thereof, the opening 18 being sealed by means of a suitable seal 22, held in place by a circumferential, annular type fastener 20.

Preferably, seal 22 is semi resilient and constructed from a material susceptible to piercing by a hollow needle-like tubular piercer 24, adapted to pierce seal 22 which at the same time becomes substantially sealed thereabout. As seen, closure 12 is threaded such that rotationally displacing fastener 20 in a specified direction designated by arrow “A”, results in a complimentary controlled vertical displacement of tubular piercer 24, so as to pierce or puncture seal 22, thereby to permit fluid flow through hollow piercer 24.

Preferably, tubular piercer 24 is biased by means of a spring or other suitable biased element 30, in the direction opposite to the direction in which rotation of closure 12 would be required so as to achieve a desired linear displacement in order to pierce seal 22, thereby to substantially prevent inadvertent puncturing thereof. Tubular piercer 24 is preferably attached to, or integrally formed with a suitable filter 26 for filtering material displaced through tubular piercer 24 and for removing, from the material, of impurities and debris.

Preferably, an attachment socket 28 is formed in closure 12 for readily accommodating and sealing several types of dispensing means in closure 12.

Thus seal 22 may be punctured for the dispensing of a selected quantity of a substance 32 contained in container 10 by rotationally displacing closure 12 in a first direction, the result of which is shown in FIG. 1C. Thereafter., upon completion of dispensing all or part of substance 32 from container 10, for example, to the level shown in FIG. 1C, hollow piercer 24 may be retracted and withdrawn through seal 22 by rotationally displacing closure 12 in the opposite direction to that required for piercing.

Preferably, filter 26 sterilizes substance 32 while it passes through filter 26. More preferably, filter 26 filters out any bacteria, viral infectors or any other potential contamination source.

A rotator key 34 (FIG. 1B) may also be provided for ready attachment to rotator 16, as via sockets 34′ formed therein, so as to aid in the rotational displacement of closure 12.

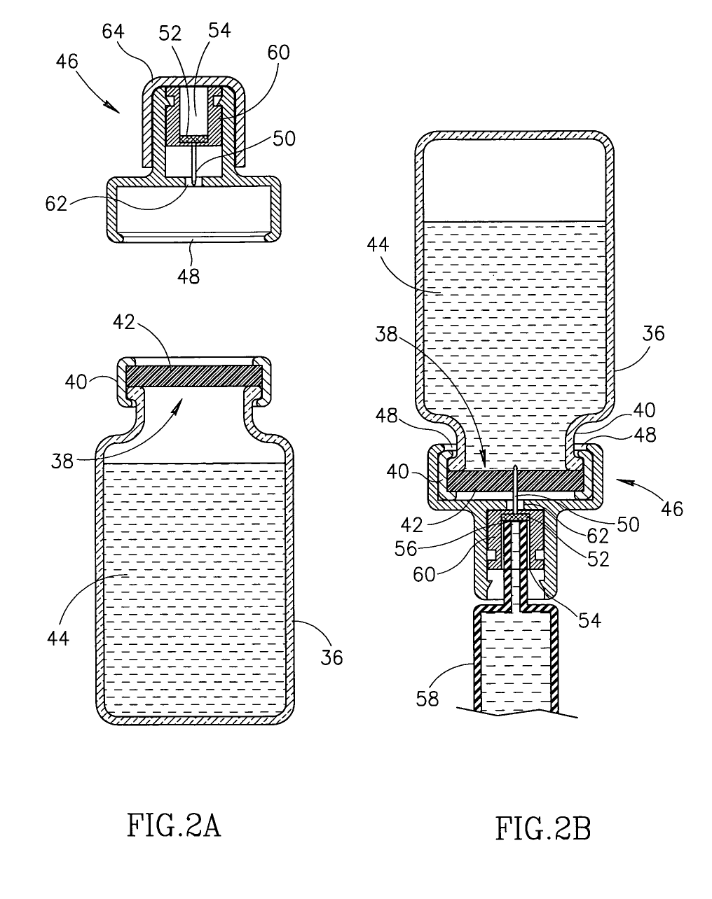

FIG. 2A and FIG. 2B show, in cross section, a vial 36 including an opening 38 formed at an upper portion of medicament vial 36 and an adapter 46, in accordance with a second embodiment of the present invention. Vial 36 includes a fastener 40 for fastening a seal 42 to opening 38 formed at an upper portion of vial 36. For the purpose of dispensing a medicament 44 from vial 36, a dispensing adapter 46 includes a gripper 48 for being readily attached to vial 36.

Medicament 44 can include, by way of example only, vaccines and materials for chemotherapy treatment.

Preferably, seal 42 is semi resilient and constructed from a material facilitating piercing by a tubular needle 50 situated in adapter 46. Preferably, piercing seal 42 with tubular needle 50 substantially contemporaneously seals seal 42 about tubular needle 50. Preferably and substantially simultaneously, fluid flow is readily facilitated in tubular needle 50.

Tubular needle 50 is preferably attached to, or integrally formed with a vial filter 52 for filtering medicament 44 displaced through tubular needle 50 and for removing, from medicament 44, impurities and debris. Preferably, filter 52 is of a suitable type so as to sterilize medicament 44 as it passes therethrough. More preferably, filter 52 filters out any bacteria, viral infectors or any other potential contamination source.

Preferably, an attachment socket 54 is formed in 46 for readily accommodating and sealing a tip 56 of a syringe 58 (FIG. 2B).

Preferably, tubular needle 50 is biased with a bias 60 substantially preventing inadvertent piercing of seal 42.

The dispensing of a quantity of medicament 44 from vial 36, may be achieved by inserting tip 56 of syringe 58 into socket 54 formed in adapter 46, thereby displacing tubular needle 50 through an aperture 62 formed in a lower portion of adapter 46, piercing seal 42 and further displacing tubular needle 50 into vial 36 (FIG. 2B).

For the purpose of substantially preventing inadvertent insertion of objects into socket 54 formed in adapter 46, a protective removable cap 64 covers socket 54, thereby preventing access to socket 54 until protective cap 64 is removed (FIG. 2A).

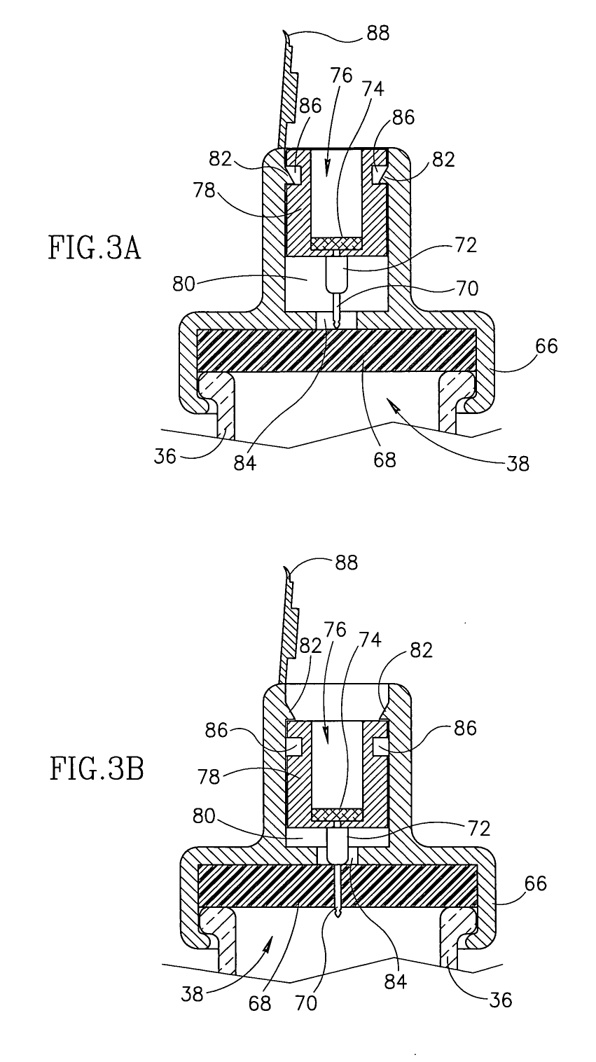

FIG. 3A and FIG. 3B show, in cross section, an upper portion of vial 36, having an opening 38 formed at an upper portion thereof, and adapter 66, constructed an operative in accordance with a third embodiment of the present invention.

As shown in FIG. 3A and FIG. 3B, vial 36 preferably includes an integral adapter 66 for fastening a seal 68 to opening 38 formed at an upper portion of vial 36. Preferably, vial 36 is manufactured with integral dispensing adapter 66 attached to vial 36, thereby securing seal 68 to opening 38 formed at an upper portion of vial 36.

Similarly, seal 68 is preferably semi resilient and constructed from a material facilitating piercing by a dispensing needle 70 situated in adapter 66. Preferably, piercing seal 68 with dispensing needle 70 substantially contemporaneously seals seal 68 about dispensing needle 70. Preferably and substantially simultaneously, fluid flow is readily facilitated in dispensing needle 70. Dispensing needle 70 is preferably attached to, or integrally formed with a unidirectional valve 72 for facilitating flow of fluids in dispensing needle 70 in one direction only.

Preferably, a dispensing filter 74 filters material displaced through dispensing needle 70 and removes, from the material, impurities and debris. Also, preferably, filter 74 sterilizes any material flowing therethrough. More preferably, filter 74 filters out any bacteria, viral infectors or any other potential contamination source.

Preferably, a syringe socket 76 is formed in adapter 66 for readily accommodating and sealing therewith the end portion of a syringe (not shown). Preferably, unidirectional valve 72 facilitates a liquid flow through dispensing needle 70, only when a syringe is located in socket 76 of adapter 66.

Preferably, dispensing needle 70 is attached to, or integrally formed with an insert 78 accommodated by a channel 80 formed in adapter 66. Preferably, insert 78 is affixed to channel 80 formed in adapter 66 with protrusions 82 for substantially preventing inadvertent piercing of seal 68.

Dispensing of the contents of vial 36 may be achieved by insertion of the tip of a syringe into socket 76, thereby to displace insert 78 substantially downwards, namely, towards vial 36. Thus, the force applied causes a displacement of insert 78 past protrusions 82, resulting in dispensing needle 70 being complimentarily displaced through an aperture 84 formed in a lower portion of adapter 66, thereby piercing seal 68 and entering into vial 36 (FIG. 3B).

Preferably, insert 78 includes recesses 86 for accommodating and securing protrusions 82 prior to inserting dispensing needle 70 through seal 68. More preferably, subsequent to inserting dispensing needle 70 through seal 68 protrusions 82 secure insert 78, thereby preventing removal of dispensing needle 70 out of seal 68.

For the purpose of substantially preventing inadvertent insertion of objects into socket 76, formed in insert 78, and channel 80 formed in adapter 66, a protective cover 88 covers socket 76 and channel 80, thereby preventing access to socket 76 and channel 80, until protective cover 88 is removed.

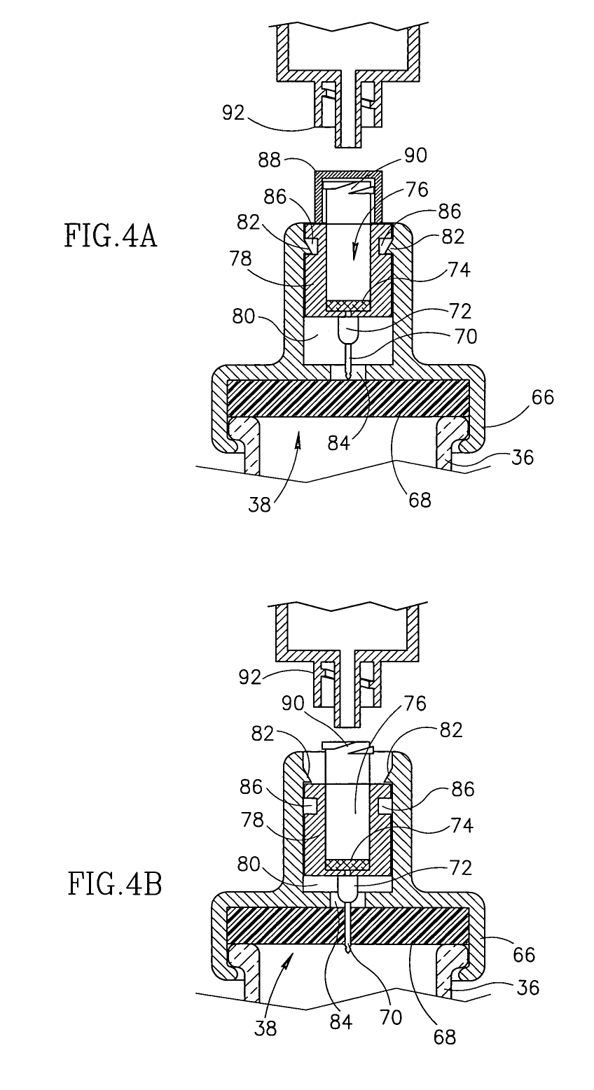

FIGS. 4A and 4B show, in cross section, an upper portion of vial 36, adapter 66 and a male luer-lock 90 for readily securing a female luer-lock 92, thereby facilitating attaching a wide range of medical attachments featuring female luer-locks 92, in accordance with a fourth embodiment of the present invention.

Preferably, unidirectional valve 72 facilitates liquid flowing through dispensing needle 70, only when a female luer-lock 92 is attached to male luer-lock 90.

A user who wishes to dispense the contents of vial 36, inserts a tip of a syringe with a female luer-lock 92 to male luer-lock 90 into socket 76, formed in insert 78, physically displacing insert 78 substantially downwards. Thus, the force applied by the user displaces insert 78 past protrusions 82, resulting in dispensing needle 70 being complimentarily displaced through aperture 84 formed in a lower portion of adapter 66, thereby piercing seal 68 and entering/being displaced into vial 36 (FIG. 4B).

Preferably, a dispensing filter 74 filters material displaced through dispensing needle 70 and removes, from the material, impurities and debris. Preferably, filter 74 sterilizes any material dispensed therethrough. More preferably, filter 74 filters out any bacteria, viral infectors or any other potential contamination source.

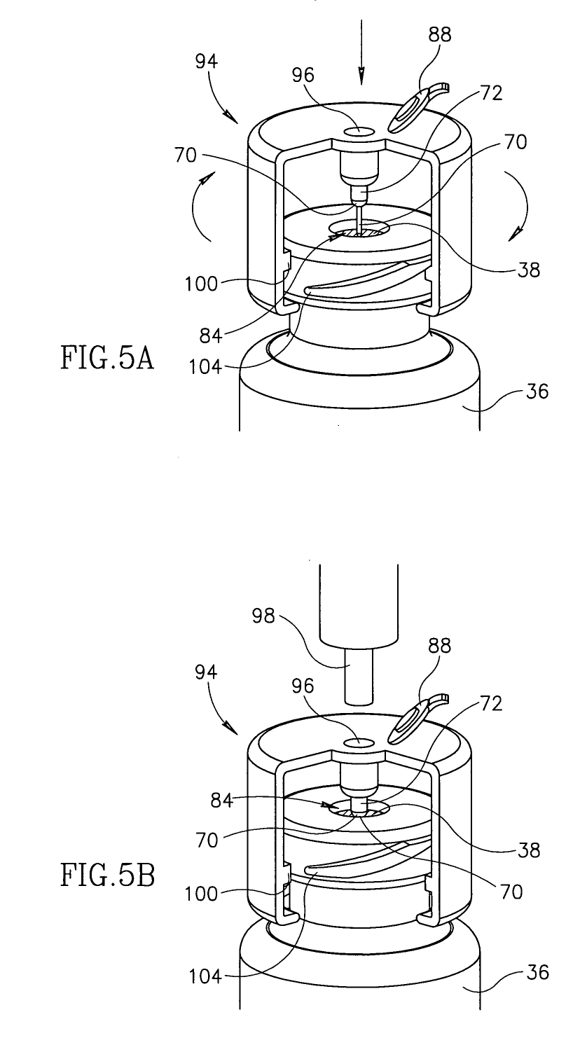

FIG. 5A and FIG. 5B are cut-away views of an upper portion of a medicament container with a vertically displaceable lockable piercer, in accordance with a fifth embodiment of a safety dispensing system.

Seal 68 (FIG. 3A) of vial 36 is preferably semi resilient and constructed from a material facilitating piercing by a dispensing needle 70 (FIG. 5A) situated in a rotatable cover 94. Preferably, piercing seal 68 with dispensing needle 70 substantially contemporaneously seals seal 68 about dispensing needle 70. Preferably and substantially simultaneously, fluid flow is readily facilitated in dispensing needle 70.

Here as well, dispensing needle 70 is preferably attached to, or integrally formed with a unidirectional valve 72 for facilitating flow of fluids in dispensing needle 70 in one direction only.

Preferably, a syringe receptacle 96 is formed in rotatable cover 94 for readily accommodating and sealing a syringe tip 98 (FIG. 5B) in rotatable cover 94. Preferably, unidirectional valve 72 facilitates liquid flowing through dispensing needle 70, only when syringe tip 98 is situated in syringe receptacle 96 formed in rotatable cover 94.

A user, wishing to dispense the contents of vial 36, inserts syringe tip 98 into syringe receptacle 96, formed in rotatable cover 94, substantially subsequent to physically rotatably displacing rotatable cover 94 thereby displacing dispensing needle 70 substantially downwards. Thus, the user displaces rotatable cover 94 such that a protrusion 100, formed in rotatable cover 94, is displaced past a leading rail resulting in dispensing needle 70 being complimentarily displaced through an aperture 84 formed in vial 36, thereby piercing seal 68 (FIG. 5B).

Preferably, leading rail 102 includes a substantially blunt end 104 for securing protrusion 100 subsequent to inserting dispensing needle 70 through seal 68. The securing of protrusion 100 by blunt end 104 prevents removal of dispensing needle 70 out of seal 68. Thereafter, syringe tip 98 is readily insertable into syringe receptacle 96.

For the purpose of substantially preventing inadvertent insertion of objects or debris into syringe receptacle 96, formed in rotatable cover 94, a protective cover 88 covers syringe receptacle 96, thereby preventing access thereto, until protective cover 88 is removed.

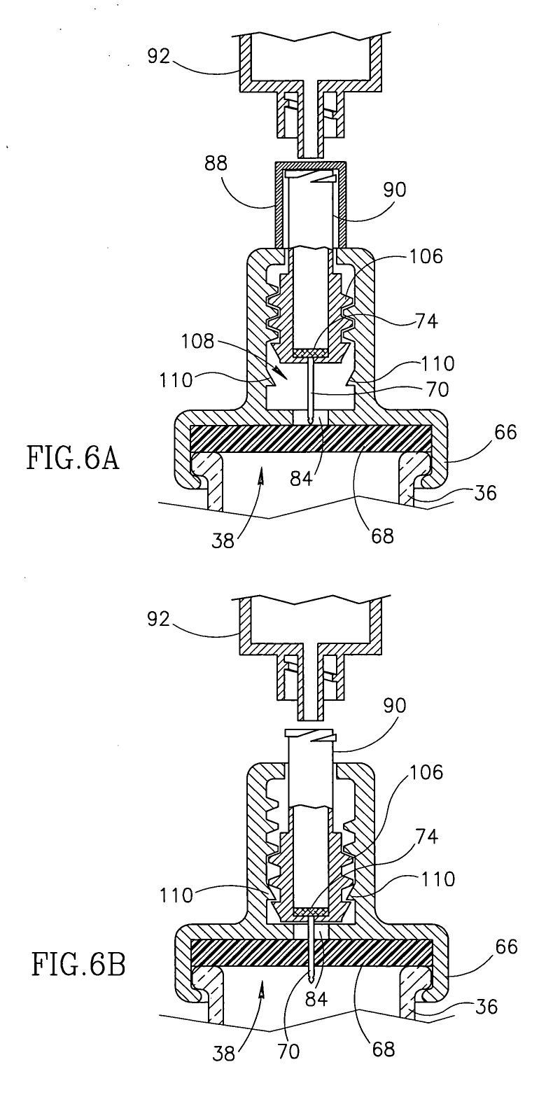

FIG. 6A and FIG. 6B show, in cross section, an upper portion of vial 36, including seal 68, an integral adapter 66 for fastening seal 68 to opening 38 formed at an upper portion of vial 36, and luer-lock 90, in accordance with a sixth embodiment of the present invention.

Seal 68 is preferably semi resilient and constructed from a semi resilient material facilitating piercing by a dispensing needle 70 situated in rotatably displaceable rotator head 106. Rotator head 106 is preferably accommodated and readily rotatable in a rotating channel 108 formed in integral adapter 66, such that rotating rotator head 106 in rotating channel 108 results in a complimentary substantially vertical displacement of rotator head 106 and needle 70.

Preferably, piercing seal 68 with dispensing needle 70 substantially contemporaneously seals seal 68 about dispensing needle 70. Preferably and substantially simultaneously, fluid flow is readily facilitated in dispensing needle 70. A dispensing filter 74 filters material displaced through dispensing needle 70 and removals, from the material, impurities and debris. In addition, filter 74 preferably sterilizes any material dispensed therethrough. More preferably, filter 74 filters out any bacteria, viral infectors or any other potential contamination source.

Preferably, the safety dispensing system of the present invention includes a male luer-lock 90, attachable to adapter 66, for readily securing a female luer-lock 92, thereby facilitating attaching a wide range of medical attachments featuring female luer-locks 92.

A protective cover 88 (FIG. 6A) covers male luer-lock 90 and rotating channel 108 formed in adapter 66, thereby preventing access to male luer-lock 90 and rotating channel 108, until protective cover 88 is removed.

A user wishing to pierce seal 68 and dispense the contents of vial 36, attaches female luer-lock 92 to male luer-lock 90 by rotating female luer-lock 92. Upon female luer-lock completing the rotation and locking to male luer-lock 90, rotational displacement is imparted on rotatable head 106, thereby rotationally displacing rotatable head 106 in rotating channel 108. Thus, rotator head 106 is displaced substantially towards seal 68 until needle 70 is displaced through aperture 84 and pierces seal 68 (FIG. 6B).

Preferably, adapter 66 includes at least one locking protrusion 110 for locking rotator head 106, preventing its displacement, and for preventing needle 70 from being removed from seal 68, subsequent to its piercing by needle 70.

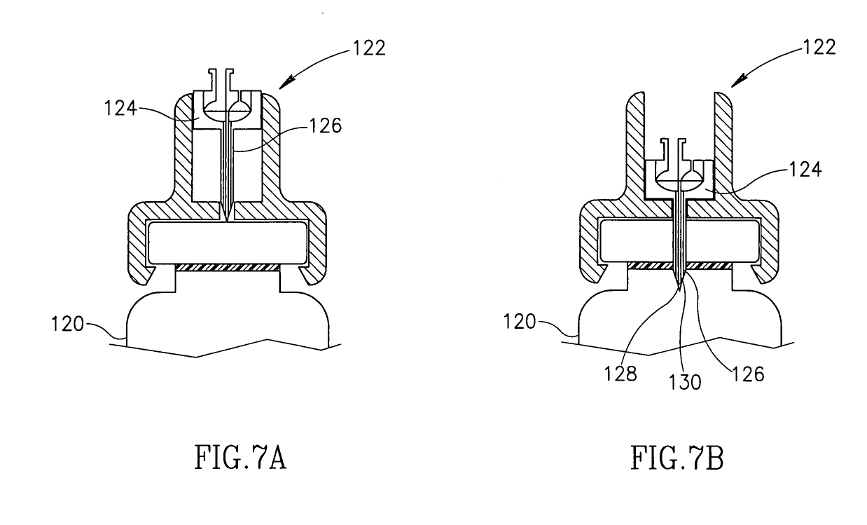

Referring now briefly to FIGS. 7A and 7B, there is seen a safety dispensing system, referenced generally 122, fastened to a container 120, prior to and after operation. System 122 is intended to schematically represent any of the embodiments shown and described above in conjunction with any of FIGS. 1A-6B. System 122 includes a movable insert 124 mounted for linear or rotational displacement with respect to the remainder of system 122 and container 120, and has a piercing and dispensing element or needle 126. The function of needle 126 and insert 124 is substantially as described above in conjunction with any of the above embodiments, and is thus not described specifically again herein.

In the present embodiment, however, element 126 is characterized by having first and second parallel bores, respectively referenced 128 and 130, wherein first bore 128 is operative to permit the entry into container of water or other liquid, if required for dissolution of, e.g., a powdered medication, and dispensing from the container of the medication. Second bore 130 is provided so as to permit atmospheric air communication between the interior of the container and the atmosphere. This is an advantage when dispensing a liquid from the container, so as to avid the creation of vacuum pressures therein, due to the fact that container is sealed. It is further useful, in the event that the contents of the container is a powder requiring dissolution, in which case, if water, for example, is sought to be added, excess air inside the container can exit therefrom via second bore 130. Although the present invention has been described in terms of vials for medicaments and bottles, it will be appreciated that the present invention may be used with any containers constructed of any material for the purpose of preventing contamination, spillage, risks of exposed needles and the like.

It will be appreciated that the present invention is not limited to what has been shown and described hereinabove, merely by way of example. Rather, the scope of the present invention is limited solely by the scope of the claims, which follow.

What is claimed is:

1. A safety dispensing system for dispensing the fluid contents of a container, wherein the system includes:
a. a fastener attached to the container for fastening a seal to an opening formed in the container;
b. a closure attached to the container for closing the opening formed in the container, wherein said closure is substantially vertically displaceable above the container, said closure including:
i. a sealable cap attached to said closure for readily accessing the opening formed in the container; and
ii. a tubular piercer attached to said closure such that rotational displacement of said closure results in a complimentary displacement of said tubular piercer and piercing of said seal, thereby facilitating flow of the material contained in the container.

2. The safety dispensing system of claim 1, wherein said tubular piercer further includes a filter for filtering the material contained in the container and for removing impurities and debris from the material.

3. The safety dispensing system of claim 2, wherein said filter is a sterilization filter.

4. The safety dispensing system of claim 1, wherein said closure further includes an attachment socket formed in said closure for readily accommodating and sealing several types of container dispensing means in said closure.

5. The safety dispensing system of claim 1, wherein said tubular piercer is biased with a bias for substantially preventing inadvertent piercing of said seal.

6. The safety dispensing system of claim 1, wherein said tubular piercer is biased with a bias for substantially preventing removal of said tubular piercer from said seal subsequent to the piercing of said seal.

7. The safety dispensing system of claim 1, wherein said closure is threaded such that rotational displacement of said closure results in a complimentary vertical displacement of said tubular piercer.

8. A safety dispensing system according to claim 1, wherein said tubular piercer is formed with a first bore for the throughflow of the material in the container, and a second bore facilitating atmospheric air communication between the interior of the container and the atmosphere.

9. A safety dispensing system for dispensing the contents of a container comprising:
a. a medicament vial for containing a liquid medicament:
i. an opening formed at an upper portion of said medicament vial;
ii. a seal sealing said opening of said medicament vial; and
iii. a fastener for fastening said seal to said opening formed at said upper portion of said vial; and
b. a dispensing adapter attached to said vial, said adapter including a needle for piercing said seal and dispensing said medicament.

10. The safety dispensing system of claim 9, further comprising a filter attached to said needle for filtering said medicament contained in said vial and for removing impurities and debris from said medicament.

11. The safety dispensing system of claim 10, wherein said filter is a sterilization filter.

12. The safety dispensing system of claim 9, wherein said needle is biased with a bias for substantially preventing inadvertent piercing of said seal.

13. The safety dispensing system of claim 9, wherein said needle is biased with a bias for substantially preventing removal of said needle from said seal subsequent to the piercing of said seal.

14. The safety dispensing system of claim 13, wherein said needle further includes a valve for controlling the flow of said medicament through said dispensing adaptor.

15. The safety dispensing system of claim 9, wherein said dispensing adapter includes a channel formed in said dispensing adapter for readily accommodating an insert in said channel formed in said dispensing adapter.

16. The safety dispensing system of claim 14, wherein said insert further includes at least one recess for readily accommodating a protrusion formed in said dispensing adapter, thereby substantially preventing removal of said needle from said seal.

17. The safety dispensing system of claim 9, further comprising a luer-lock.

18. The safety dispensing system of claim 17, wherein said luer-lock is attached to said adapter, for substantially complimentary rotatable displacement of said luer-lock and said adapter.

19. A safety dispensing system according to claim 9, wherein said needle is formed with a first bore for the throughflow of the material in the container, and a second bore facilitating atmospheric air communication between the interior of the container and the atmosphere.

20. A safety dispensing system for dispensing the contents of a container comprising:
a. a medicament vial including:
i. a medicament;
ii. an opening formed at an upper portion of said medicament vial;
iii. a seal sealing said opening of said medicament vial; and
iv. a fastener for fastening said seal to said opening formed at said upper portion of said vial; and
b. a rotatable cover attached to said vial, said rotatable cover including:
i. a needle for piercing said seal and dispensing said medicament;
ii. a syringe receptacle formed in said rotatable cover for readily accommodating and sealing a syringe tip in said rotatable cover; and
iii. a protrusion formed in said rotatable cover for securing said rotatable cover subsequent to said needle piercing said seal.

21. The safety dispensing system of claim 20, wherein said needle further includes a filter for filtering said medicament contained in said vial and for removing impurities and debris from said medicament.

22. The safety dispensing system of claim 21, wherein said filter is a sterilization filter.

23. The safety dispensing system of claim 20, wherein said needle is readily securable in said seal subsequent to the piercing of said seal with said needle.

24. A safety dispensing system according to claim 20, wherein said needle is formed with a first bore for the throughflow of the material in the container, and second bore facilitating atmospheric air communication between the interior of the container and the atmosphere.
